(19) United States
(12) Patent Application Publication
(10) Pub. No.: US 2024/0265825 A1
(43) Pub. Date: Aug. 8, 2024

(54) SYSTEM AND METHOD FOR ENCOURAGING ACTIVITY VIA ACTIVITY PACKS

(71) Applicant: carter joey LLC, Pittsburgh, PA (US)

(72) Inventors: Damon Joseph Claus, Pittsburgh, PA (US); Abby DiBenedetto Sliger, Oakmont, PA (US); Catherine Ann Claus, Pittsburgh, PA (US)

(21) Appl. No.: 18/432,368

(22) Filed: Feb. 5, 2024

Related U.S. Application Data
(60) Provisional application No. 63/443,468, filed on Feb. 6, 2023.

(51) Int. Cl. G09B 19/00

(52) U.S. Cl. CPC G09B 19/00

(57) ABSTRACT

Methods for motivating children to engage in activities are described herein. Some versions of these methods include providing an activity pack to a child, wherein the activity pack includes at least one instruction associated with an activity to perform. Some versions of these methods include providing a physical badge to the child upon completion of the activity by the child, wherein the physical badge is associated with the activity. Some versions of these methods include providing an electronic badge to the child upon completion of the activity, wherein the electronic badge is associated with the activity, wherein the electronic badge is viewable on a webpage associated with the child.

### BACKGROUND

There are many educational activities and games available for children, but they are often in the form of books or apps, which do not provide a tangible reward for completion. Additionally, many children enjoy showing off their achievements to others, but there is often no way to do so in a physical or electronic manner. Further, if a child shows interest in a particular activity, there may not be a readily available option to provide additional learning opportunities for the child on that subject. Therefore, the need exists to improve upon the traditional methods of motivating children to engage in educational and recreational activities.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 depicts an exemplary system for motivating children to engage in activities, incorporating an exemplary activity pack, an exemplary backpack, and an exemplary webpage;

FIG. 2 depicts an exemplary method for motivating children to engage in activities;

FIG. 3 depicts an exemplary webpage for displaying exemplary electronic badges;

FIG. 4 depicts an exemplary activity pack in the form of an exemplary patch pack, along with and exemplary backpack in the form of a sling pack;

FIG. 5 depicts another view of the exemplary backpack of FIG. 4; and

FIG. 6 depicts an exemplary method for motivating children to engage in activities.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

It will be appreciated that any one or more of the teachings, expressions, versions, examples, etc. described herein may be combined with any one or more of the other teachings, expressions, versions, examples, etc. that are described herein. The following-described teachings, expressions, versions, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

### I. PROVIDING EXPERIENCES THROUGH ACTIVITY PACKS AND BADGES

The present invention relates to a system and method for providing children with an interactive and educational experience through the use of activity packs and badges. As used herein, “activity packs” may take the form of a pack with patches or badges and information or instructions associated with each patch. The term “patch pack” may be used interchangeably with “activity pack” to provide additional context regarding the physical elements provided to a user. Activity packs and patch packs may include badges in the form of “patches,” or any other physical format of a badge. The invention may include providing (e.g. mailing or purchasing) a child an activity/patch pack which, upon completion of the specified activity or instructions, allows the child to earn a physical badge to place on a backpack, sling pack, bag, hat, or any other physical item, as well as an electronic version of the badge to use on a webpage associated with the child.

The activity packs of the present invention include a variety of interactive and educational activities, such as puzzles, games, crafts, or activities to perform, such as painting a rock, or donating a toy. These activities are designed to encourage learning and creativity in children, while also providing a sense of accomplishment upon completion. The activities can be customized to the child's age and interests, ensuring that the child is challenged and engaged.

In one version of the invention, the activity packs are mailed to the child's residence, where the child can complete the activities at their own pace. Once the child completes an activity pack, they are able to claim their badge by mail or by an electronic means, such as by visiting a website associated with the activity pack. The badge is a physical item that can be placed on a backpack or bag, serving as a tangible symbol of the child's accomplishment. Additionally, the badge can be used on a webpage associated with the child, where it can be displayed and shared with others. In other versions of the activity pack, a parent or other caregiver provides the activity pack and badge to the child to pursue.

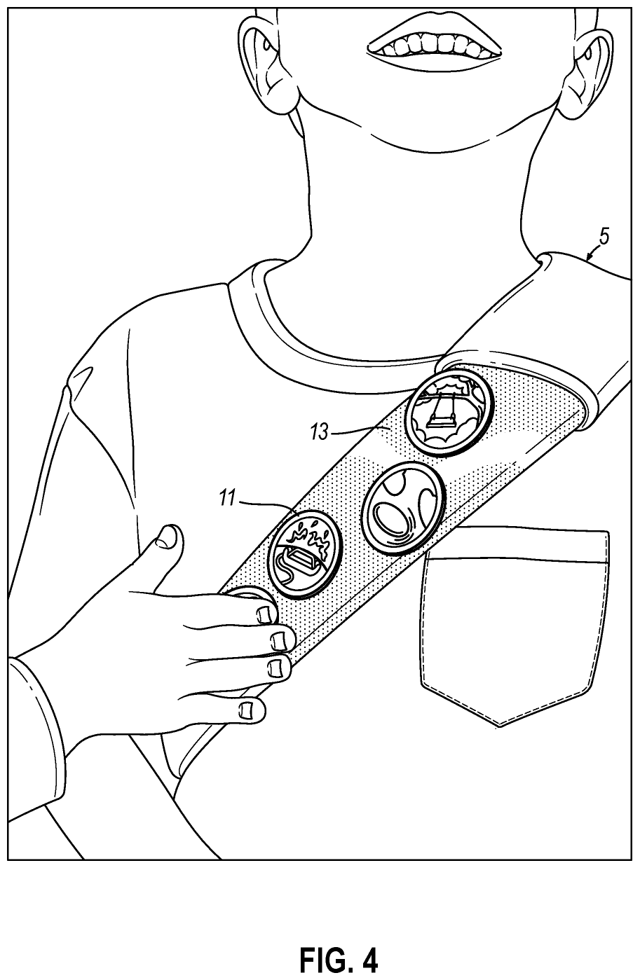

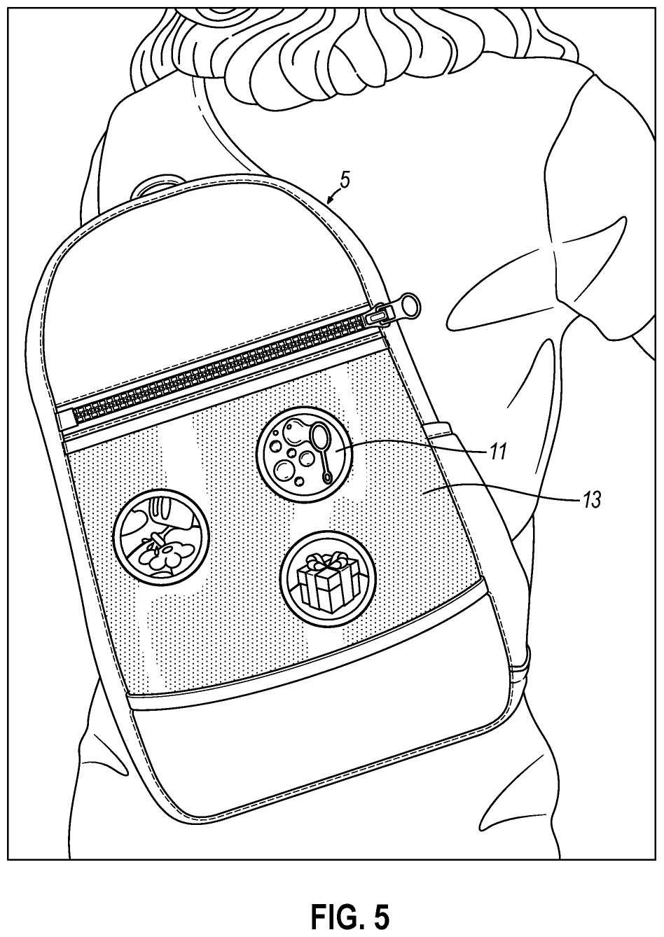

In another version of the invention, activity packs may take the form of “patch packs” which include physical badges in the form of patches to be placed on a backpack, bag, or sling pack. Each patch itself may include the activity instructions, such as a patch that says “Paint A Rock” on the front of the patch itself. When I child receives the patch, they are encouraged to engage in the activity to “earn” placement of the patch on the child's backpack or sling pack. An example of this version of the present invention is depicted in FIGS. 4 and 5. Patches on patch packs may include a connection mechanism on the back of the patch to enable a user to secure the patch onto a backpack or sling pack. For example, a hook and loop fastener system may be used.

The webpage associated with the child can be accessed using a unique code or identifier provided with the activity pack. On the webpage, the child can view their badges, as well as share their accomplishments with friends and family. The webpage can also include additional interactive and educational content, such as puzzles and games, further enhancing the child's experience. Additional elements may be incorporated into the webpage (or website) such as learning and life experiences information, educational content, expert insight, and encouragement for various positive habits and an active lifestyle. The website may also request feedback on the “activity” experience (or any other information) in accordance with an online learning center approach. Details such as memories of the activity, the date, or co-participants can also be solicited and entered by the user.

The webpage can also have a feature that allows the child to connect with other children who have completed the activity pack, creating a sense of community and encouraging friendly competition. The webpage can also have a feature that allows the child to connect with educators or parents, allowing them to monitor the child's progress and offer support.

The present invention provides a unique and interactive way for children to learn and grow, while also providing a sense of accomplishment through the use of badges. The activity packs and badges can be used in a variety of settings, such as in schools, libraries, or at home.

One aspect of the invention is a system for motivating children to engage in activities, comprising a backpack associated with a child; a webpage associated with the child; a mechanism for providing an activity pack to the child, wherein the activity pack includes at least one instruction associated with an activity to perform, wherein following the at least one instructions results in completion of the activity; a mechanism for awarding a physical badge to the child upon completion of the activity; a mechanism for connecting the physical badge to the backpack; a mechanism for awarding an electronic badge to the child upon completion of the activity; and a mechanism for connecting the electronic badge to the webpage.

Another aspect of the invention is a method for motivating children to engage in activities, the method comprising: providing an activity pack to a child, wherein the activity pack includes at least one instruction associated with an activity to perform; upon completion of the activity by the child, providing a physical badge to the child, wherein the physical badge is associated with the activity; and upon completion of the activity, providing an electronic badge to the child, wherein the electronic badge is associated with the activity, wherein the electronic badge is viewable on a webpage associated with the child.

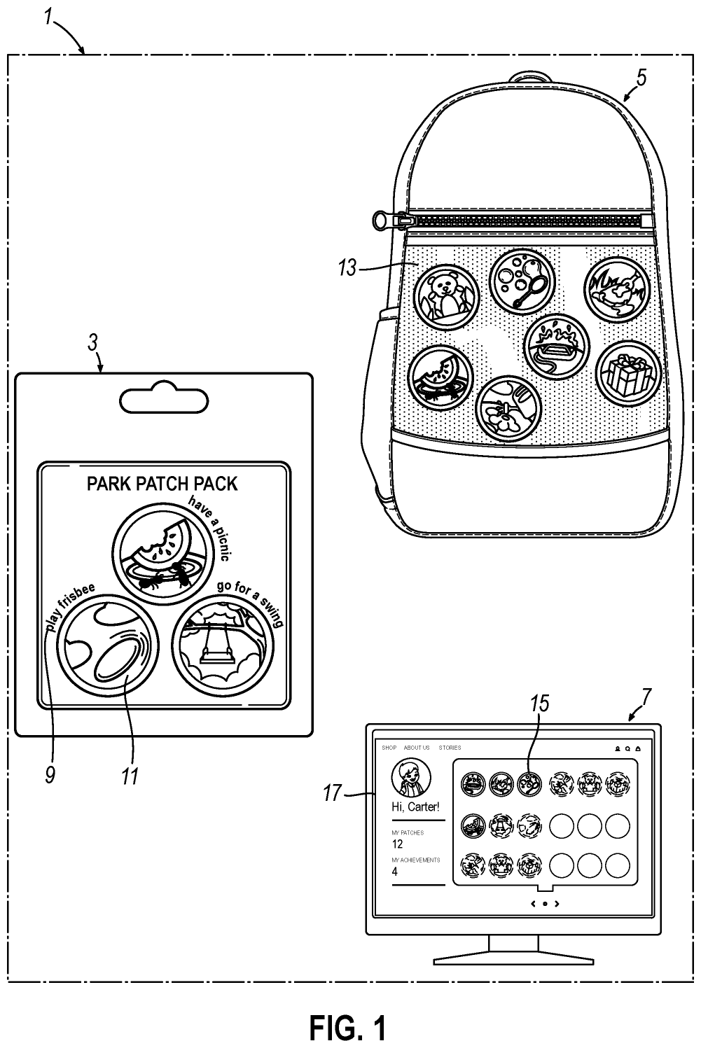

To illustrate, FIG. 1 depicts a system (1) for motivating children to engage in activities in accordance with some versions of the present invention. System (1) includes an activity pack or a group of patches in a “patch pack,” referred to hereinafter as activity pack (3), a backpack (5), and a webpage (7). Activity pack (3) is associated with a least one activity and each activity is associated with at least one instruction (9) such as “play frisbee.” In this particular example, a physical badge (11) associated with the activity is provided within activity pack (3). Physical badge (11) may be referred to alternatively as a “patch,” as shown in FIGS. 4 and 5, as physical badge (11) may be placed on backpack (5) in a patch-like manner. In other examples, physical badge (11) may be provided separately from activity pack (3), such as by mailing to a recipient. Likewise, the participant or the participant's caregiver can obtain activity pack (3) in person, such as via a retail store, or may order activity pack (3) to be delivered by mail.

Activity pack (3) may also be embodied in a patch pack, such as shown in FIG. 1. Patch pack may be a purchasable item with one or more physical badges (11) in the form of a patch with an activity instruction (9) either on the patch itself or surrounding the patch on a cardboard backing. For example, the particular activity pack (3) (also known as “patch pack”) shown in FIG. 1 includes three physical badges (11), with instructions placed near the physical badges (11) and a graphical representation of the activity on the physical badge (11) itself (i.e. “have a picnic” with a stylized representation of two ants near a watermelon).

In accordance with system (1), once a participate engages in the activity pursuant to the at least one instruction (9), the activity can be considered completed. Upon completion of the activity, physical badge (11) associated with the activity is provided to the participant. Physical badge (11) may be placed onto an attachment section (13) of backpack (5) to enable the participant to show others the accomplishment of engaging in the activity. Some versions of attachment section (13) may incorporate a hook and loop type of mechanism for releasably connecting each physical badge (11) to attachment section (13). Other versions may presume a stitching or sewing engagement between physical badge (11) and attachment section (13). However, any common or reasonable method for connecting physical badge (11) with backpack (5) is encompassed by the present invention.

Further, an electronic badge (15) associated with the activity is provided to the participant and delivered electronically via a link or QR code or any other common mechanism for connecting participant with electronic badge (15). Once the activity is completed, electronic badge (15) may be digitally placed onto webpage (7), which is associated with the participant. Within webpage (7), content related to the activity, referred to hereinafter as a related content (17), may be provided so the participant can further study, understand, and/or engage with the subject matter of the activity. For example, related content (17) may include a video or a fact about the activity; information on related life experiences or learning modules; encouragement for additional activities or other general directives; and prompts or information on developing positive habits. Further, related content (17) may include prompts or solicitations for the user to provide feedback on the activity and/or additional details, such as details about the activity (date of completion, information on the experience, names of co-participants, etc.) to act as an online repository for surrounding details on the activity engagement. Administrators of webpage (7) may utilize this data in furtherance of marketing, learning, or other data-driven goals.

Thus, system (1) can act to motivate a child to engage in activities by providing badges upon completion of an activity. System (1) provides both physical badge (11) to show the accomplishment to others in person, and an electronic badge (15) to show others the accomplishment online. System (1) has the additional benefit of incorporating related content (17) into the provision of the electronic badge (15) to further bolster the participants interest in the subject. By providing a reward such as badges (11, 15), for completing activity pack (3), children are given a sense of accomplishment and motivation to continue learning. These additional learning opportunities may be provided via webpage (7) in connection with electronic badge (15).

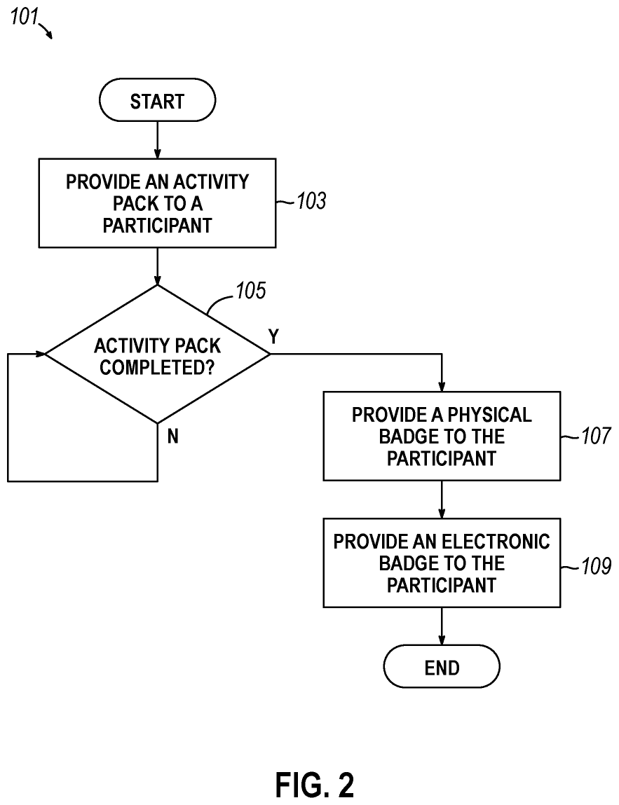

FIG. 2 depicts a method (101) for motivating children to engage in activities in accordance with some versions of the present invention. Method (101) begins with a step (103), whereby a participant is provided an activity pack, such as activity pack (3) described above. Thereafter, step (103) proceeds to a step (105), whereby an inquiry is made regarding whether the participant has completed the activity pack. If not, step (105) loops to continue to check whether the participant has completed the activity pack. If the participant has completed the activity pack, step (105) proceeds to a step (107), whereby a physical badge, such as physical badge (11) described above, is provided to the participant. Thereafter, step (107) proceeds to a step (109), whereby an electronic badge, such as electronic badge (15) described above, is provided to the participant. Thereafter, method (101) proceeds to end.

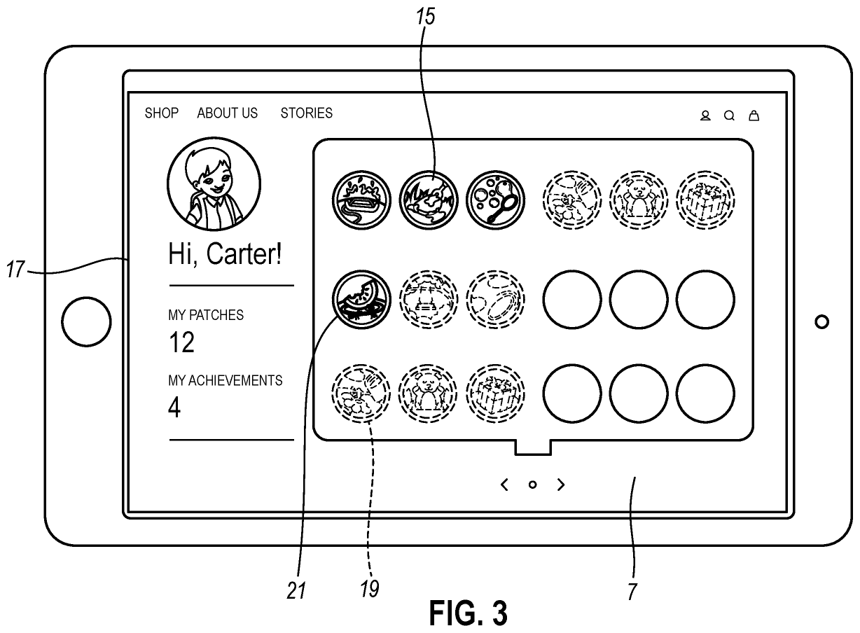

FIGS. 3-5 provide additional examples and embodiments of the various features of system (1) and/or method (101), including additional information regarding activity packs (3), backpack (5), and webpage (7). FIG. 3 depicts additional information regarding webpage (7), shown on an iPad with a variety of electronic badges (15) and related content (17). FIG. 4 depicts additional information regarding the “patch packs” embodiment of activity packs (3), with additional information relating to physical badges (11) and instructions (9). FIG. 5 depicts additional information relating the “sling packs” embodiment of backpack (5), with additional information relating to the panels and areas for connecting physical badges (11) to backpack (5). As shown in FIGS. 4 and 5, attachment section (13) may be on the back of backpack (5) (shown in FIG. 5) or on the shoulder strap area (shown in FIG. 4) or any other place on backpack (3).

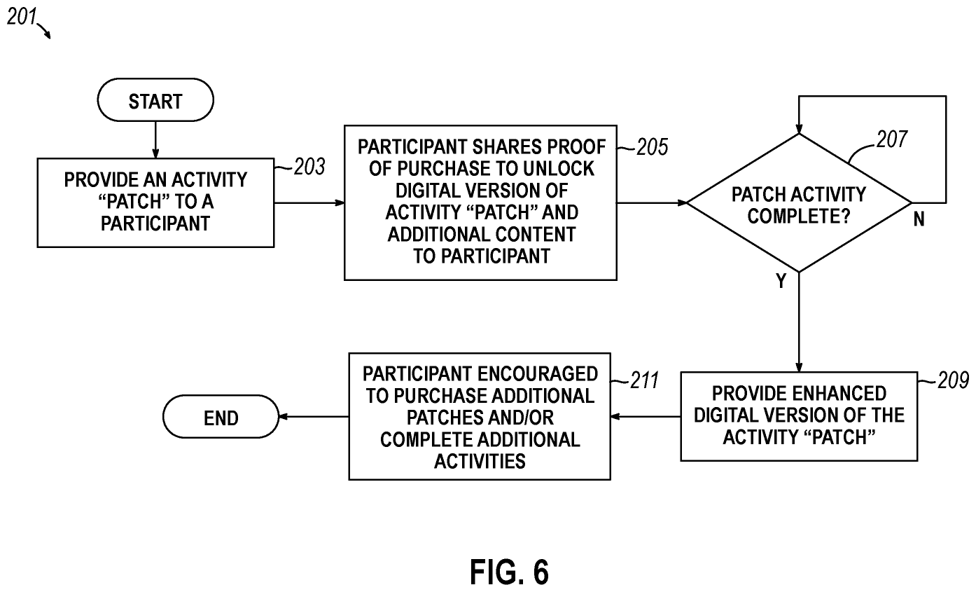

FIG. 6 depicts a method (201) for motivating children to engage in activities in accordance with some versions of the present invention. Method (201) begins with a step (203), whereby a participant is provided an activity patch, such as physical badge (11) described above. Thereafter, step (203) proceeds to a step (205).

In step (205), the participant shares proof of purchase of physical badge (11) (either singularly or as part of an activity pack (3)) with a webpage such as webpage (7) to unlock a digital version of the activity patch such as electronic badge (15) described above. In some versions of step (205), this may unlock additional content to participant as well, as described above with respect to related content (17) or may also prompt the participant to enter additional information. In some versions of step (205), the unlocked digital version of the activity patch is a first version (19) of the activity patch, as shown in FIG. 3. Thereafter, step (205) proceeds to a step (207).

In step (207), an inquiry is made regarding whether the participant has completed the instructions or activity associated with the aforementioned activity patch. If not, step (207) loops to continue to check whether the participant has completed the activity associated with the activity patch. If the participant has completed the activity associated with the activity patch, step (207) proceeds to a step (209).

In step (209), an enhanced or second version (21) of the digital activity patch is unlocked or otherwise provided to the participant on the webpage, as shown in FIG. 3. In some versions of method (201), first version (19) of the activity patch provided in step (205) may be a greyed out or otherwise “inactive” looking embodiment of the digital activity patch, while second version (21) of the activity patch provided in step (209) may be an enhanced, full colored, or otherwise activated looking version of the digital activity patch to indicate to the user that the activity has been completed and “earned.” In other words, first version (19) indicates the activity patch is available for completion, second version (21) indicates the activity patch has been earned or completed. Thereafter, step (209) proceeds to a step (211).

In step (211), the participant is encouraged to purchase additional activity patches (either physical or digital) and/or complete additional activities. In step (211) the participant may also be prompted to provided additional details related to the activity and experience, or interact with related learning content such as by watching videos or reading more about the activity related concepts such as building positive habits or engaging in active lifestyle. Thereafter, method (201) proceeds to end.

To summarize and provide additional context on the above system (1) and method (101), the present invention includes a method for tracking and monitoring a child's progress through the activity packs. The computer system associated with the webpage can track the child's completion of the activities and can provide data on the child's progress to educators or parents. This allows educators and parents to monitor the child's learning and offer support where needed. In addition, the present invention provides for the ability to update and add new activity packs to system (1) and method (101). This allows system (1) and method (101) to constantly evolve and provide new and exciting interactive and educational experiences for the child. Another aspect of the invention is the ability to customize the activity packs (3) and badges (11, 15) based on the child's interests, abilities, and learning style. This allows the child to engage with the activities in a way that is most beneficial to them, and it increases the chances of the child's success.

The present invention also relates to rewarding the child for their accomplishments. This can include providing additional physical or electronic badges (11, 15) for completing certain milestones or providing prizes for completing a certain number of activity packs (3). This provides an additional incentive for the child to continue learning and engaging with the activities.

In summary, the present invention provides a unique and interactive way for children to learn and grow, while also providing a sense of accomplishment through the use of both physical badges (11) and electronic badges (15). As noted above, activity packs (3) and badges (11, 15) can be used in a variety of settings, such as in schools, libraries, or at home, and they can be customized to the child's age, interests, abilities, and learning style. Via webpage (7), the present invention may also include a method for tracking and monitoring a child's progress, updating, and adding new activity packs, and rewarding the child for their accomplishments.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements.

### II. EXEMPLARY COMBINATIONS

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A method for motivating children to engage in activities, the method comprising: (a) providing an activity pack to a child, wherein the activity pack includes at least one instruction associated with an activity to perform; (b) upon completion of the activity by the child, providing a physical badge to the child, wherein the physical badge is associated with the activity; and (c) upon completion of the activity, providing an electronic badge to the child, wherein the electronic badge is associated with the activity, wherein the electronic badge is viewable on a webpage associated with the child.

### Example 2

The method of the previous Example or any of the subsequent Examples, further comprising mailing the activity pack to the child.

### Example 3

The method of any of the previous or subsequent Examples, further comprising mailing the physical badge to the child.

### Example 4

The method of any of the previous or subsequent Examples, wherein the webpage includes a video about the activity.

### Example 5

The method of any of the previous or subsequent Examples, wherein the webpage includes a fact about the activity.

### Example 6

A method for motivating children to engage in activities, the method comprising: (a) providing an activity pack to a child, wherein the activity pack includes at least one instruction associated with an activity to perform; (b) upon completion of the activity by the child, disposing a physical badge onto a backpack associated with the child, wherein the physical badge is associated with the activity; and (c) upon completion of the activity, disposing an electronic badge onto a webpage associated with the child, wherein the electronic badge is associated with the activity.

### Example 7

The method of any of the previous or subsequent Examples, further comprising mailing the activity pack to the child.

### Example 8

The method of any of the previous or subsequent Examples, further comprising mailing the physical badge to the child.

### Example 9

The method of any of the previous or subsequent Examples, wherein the webpage includes a video about the activity.

### Example 10

The method of any of the previous or subsequent Examples, wherein the webpage includes a fact about the activity.

### Example 11

A system for motivating children to engage in activities, comprising: (a) a backpack associated with a child; (b) a webpage associated with the child; (c) a mechanism for providing an activity pack to the child, wherein the activity pack includes at least one instruction associated with an activity to perform, wherein following the at least one instructions results in completion of the activity; (d) a mechanism for awarding a physical badge to the child upon completion of the activity; (e) a mechanism for connecting the physical badge to the backpack; (f) a mechanism for awarding an electronic badge to the child upon completion of the activity; and (g) a mechanism for connecting the electronic badge to the webpage.

### Example 12

The system of any of the previous or subsequent Examples, wherein the mechanism for providing the activity pack to the child includes mailing the activity pack to the child.

### Example 13

The system of any of the previous or subsequent Examples, wherein the mechanism for awarding the physical badge to the child includes mailing the physical badge to the child.

### Example 14

The system of any of the previous or subsequent Examples, wherein the webpage includes a video about the activity.

### Example 15

The system of any of the previous or subsequent Examples, wherein the webpage includes a fact about the activity.

### Example 16

A method for motivating children to engage in activities, the method comprising: (a) providing an activity pack to a child, wherein the activity pack includes at least one instruction associated with an activity to perform; (b) inputting a proof of purchase of the activity pack to a webpage associated with the child; (c) upon inputting the proof of purchase of the activity pack to the webpage, unlocking a first version of an electronic badge on the webpage, wherein the electronic badge is associated with the activity; and (d) upon completion of the activity, changing the first version of the electronic badge on the website to a second version of the electronic badge.

### Example 17

The method of any of the previous or subsequent Examples, wherein the webpage includes a video about the activity.

### Example 18

The method of any of the previous or subsequent Examples, wherein the webpage includes a fact about the activity.

### Example 19

The method of any of the previous or subsequent Examples, further comprising prompting, via the webpage, for information relating to the completion of the activity.

### Example 20

The method of any of the previous Examples, wherein the second version is a full color depiction of electronic badge.

### III. MISCELLANEOUS

It should be understood that any of the examples described herein may include various other features in addition to or in lieu of those described above. By way of example only, any of the examples described herein may also include one or more of the various features disclosed in any of the various references that are incorporated by reference herein.

It should be understood that any one or more of the teachings, expressions, embodiments, examples, etc. described herein may be combined with any one or more of the other teachings, expressions, embodiments, examples, etc. that are described herein. The above-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various versions of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

I/We claim:

1. A method for motivating children to engage in activities, the method comprising:
(a) providing an activity pack to a child, wherein the activity pack includes at least one instruction associated with an activity to perform;
(b) upon completion of the activity by the child, providing a physical badge to the child, wherein the physical badge is associated with the activity; and
(c) upon completion of the activity, providing an electronic badge to the child, wherein the electronic badge is associated with the activity, wherein the electronic badge is viewable on a webpage associated with the child.

2. The method of claim 1, further comprising mailing the activity pack to the child.

3. The method of claim 1, further comprising mailing the physical badge to the child.

4. The method of claim 1, wherein the webpage includes a video about the activity.

5. The method of claim 1, wherein the webpage includes a fact about the activity.

6. A method for motivating children to engage in activities, the method comprising:
(a) providing an activity pack to a child, wherein the activity pack includes at least one instruction associated with an activity to perform;
(b) upon completion of the activity by the child, disposing a physical badge onto a backpack associated with the child, wherein the physical badge is associated with the activity; and
(c) upon completion of the activity, disposing an electronic badge onto a webpage associated with the child, wherein the electronic badge is associated with the activity.

7. The method of claim 6, further comprising mailing the activity pack to the child.

8. The method of claim 6, further comprising mailing the physical badge to the child.

9. The method of claim 6, wherein the webpage includes a video about the activity.

10. The method of claim 6, wherein the webpage includes a fact about the activity.

11. A system for motivating children to engage in activities, comprising:
(a) a backpack associated with a child;
(b) a webpage associated with the child;
(c) a mechanism for providing an activity pack to the child, wherein the activity pack includes at least one instruction associated with an activity to perform, wherein following the at least one instructions results in completion of the activity;
(d) a mechanism for awarding a physical badge to the child upon completion of the activity;
(e) a mechanism for connecting the physical badge to the backpack;
(f) a mechanism for awarding an electronic badge to the child upon completion of the activity; and
(g) a mechanism for connecting the electronic badge to the webpage.

12. The system of claim 11, wherein the mechanism for providing the activity pack to the child includes mailing the activity pack to the child.

13. The system of claim 11, wherein the mechanism for awarding the physical badge to the child includes mailing the physical badge to the child.

14. The system of claim 11, wherein the webpage includes a video about the activity.

15. The system of claim 11, wherein the webpage includes a fact about the activity.

16. A method for motivating children to engage in activities, the method comprising:
(a) providing an activity pack to a child, wherein the activity pack includes at least one instruction associated with an activity to perform;
(b) inputting a proof of purchase of the activity pack to a webpage associated with the child;
(c) upon inputting the proof of purchase of the activity pack to the webpage, unlocking a first version of an electronic badge on the webpage, wherein the electronic badge is associated with the activity; and
(d) upon completion of the activity, changing the first version of the electronic badge on the website to a second version of the electronic badge.

17. The method of claim 16, wherein the webpage includes a video about the activity.

18. The method of claim 16, wherein the webpage includes a fact about the activity.

19. The method of claim 16, further comprising prompting, via the webpage, for information relating to the completion of the activity.

20. The method of claim 16, wherein the second version is a full color depiction of electronic badge.
